(19) United States
(12) Patent Application Publication
(10) Pub. No.: US 2016/0279871 A1
(43) Pub. Date: Sep. 29, 2016

(54) Device for Producing a Three-Dimensional Object in Layers

(71) Applicant: EOS GMBH ELECTRO OPTICAL SYSTEMS, Krailling (DE)

(72) Inventors: Martin Heugel, Landsberg am Lech (DE); Georg Fey, Munchen (DE)

(73) Assignee: EOS GmbH Electro Optical Systems, Krailling (DE)

(21) Appl. No.: 15/029,707

(22) PCT Filed: Nov. 7, 2014
(86) PCT No.: PCT/EP2014/074017

§ 371 Date: Apr. 15, 2016

(30) Foreign Application Priority Data
Nov. 15, 2013 (DE) 10 2013 223 407.4

(51) Int. Cl. B29C 67/00

(52) U.S. Cl. CPC B29C 67/0077; B29C 67/0092; B29C 67/0096; B29L 2031/00

(57) ABSTRACT

A device (20) for unpacking a three-dimensional object (2), produced in an interchangeable container (5) and/or on a construction platform (7) by applying layers of a construction material (11) in powder form and by selective hardening thereof, from the surrounding unhardened powder (9) contains a rotating device (22) for holding the interchangeable container (5) and/or the construction platform (7), which rotating device is able to rotate the interchangeable container (5) and/or the construction platform (7) through an angle of at least 90° out of the upright position.

The present invention relates to a device and to a method for producing a three-dimensional object in layers by solidifying building material in layers by introducing energy at those locations that in the respective layer correspond to the cross section of the object to be produced, and for unpacking the finished object from the remaining non-solidified powder surrounding said object.

A method for producing a three-dimensional object in layers, known by the name “selective laser sintering”, and an associated device for carrying out the method are disclosed in DE 10 2005 024 790 A1, for example.

WO 01/10631 describes a device and a method for unpacking a finished object from the remaining non-solidified powder surrounding said object. Upon completing the object, the container in which the object has been finished is removed from the processing chamber and moved to an unpacking station. In one embodiment, the unpacking station includes a compressed-air source from which an air stream flows tangentially across the upper side of the container. By moving the support on which the object has been constructed in the container in the direction toward the upper side of the container, the remaining non-solidified powder is steadily urged beyond the periphery of the containers and is blown off of the finished object by the air stream. The object here is simultaneously cooled. In one other embodiment, the container is tilted about a predetermined angle. By moving the support in the direction toward the upper side of the container, the remaining non-solidified powder is steadily urged beyond the periphery of the container and laterally trickles into a collection container.

In the case of this unpacking device a dedicated drive for moving the support has to be provided, on account of which the device becomes complex and large. Moreover, objects having cavities cannot be completely relieved from remaining non-solidified powder by the method described therein.

The object of the present invention lies in providing an improved device and an improved method for unpacking an object, which has been produced by solidifying pulverulent raw material in layers, from the remaining non-solidified powder surrounding said object.

The object is achieved by a device as claimed in claim 1 or 8, and by a method as claimed in claim 11 or 23. Refinements of the invention are stated in the respective dependent claims.

By rotating the interchangeable container which is received in the rotary frame by at least 90° from the upright position thereof it is achieved that the remaining non-solidified powder may trickle completely out of the interchangeable container or from cavities of the produced object, respectively. This trickling is preferably assisted by applying vibrations or knocks, respectively. The entire procedure may be carried out in an inert-gas atmosphere.

Further features and expediencies of the invention are derived from the description of exemplary embodiments by means of the appended drawings.

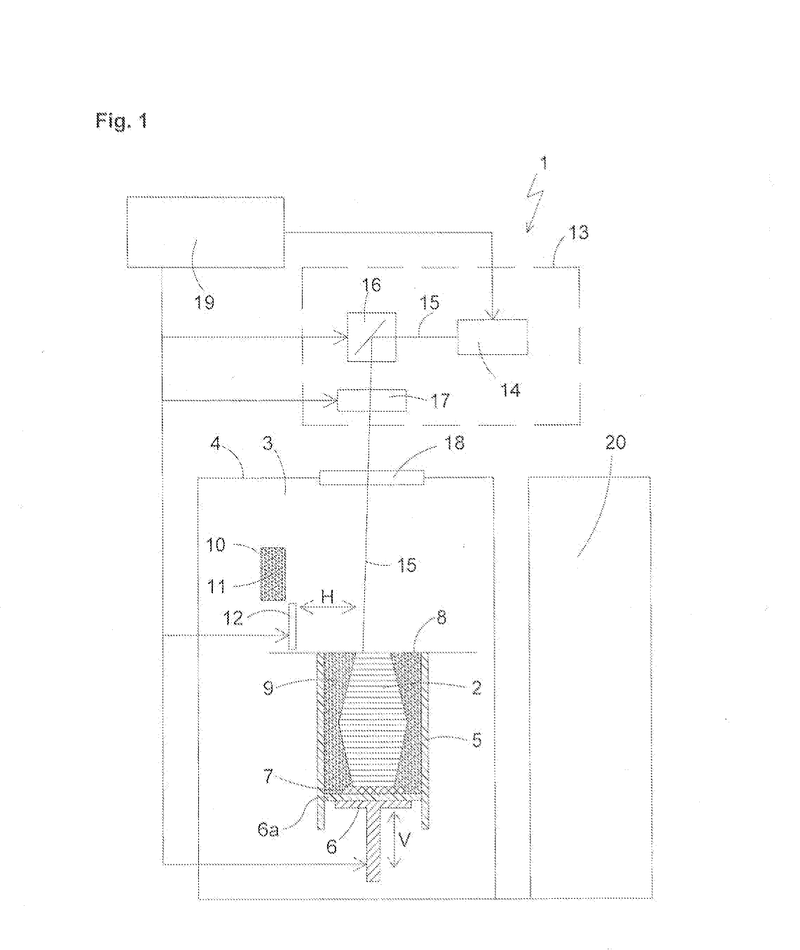

FIG. 1 shows a schematic view which is partially illustrated in the section of an exemplary embodiment of a device for producing a three-dimensional object in layers, which is suitable for carrying out the present invention.

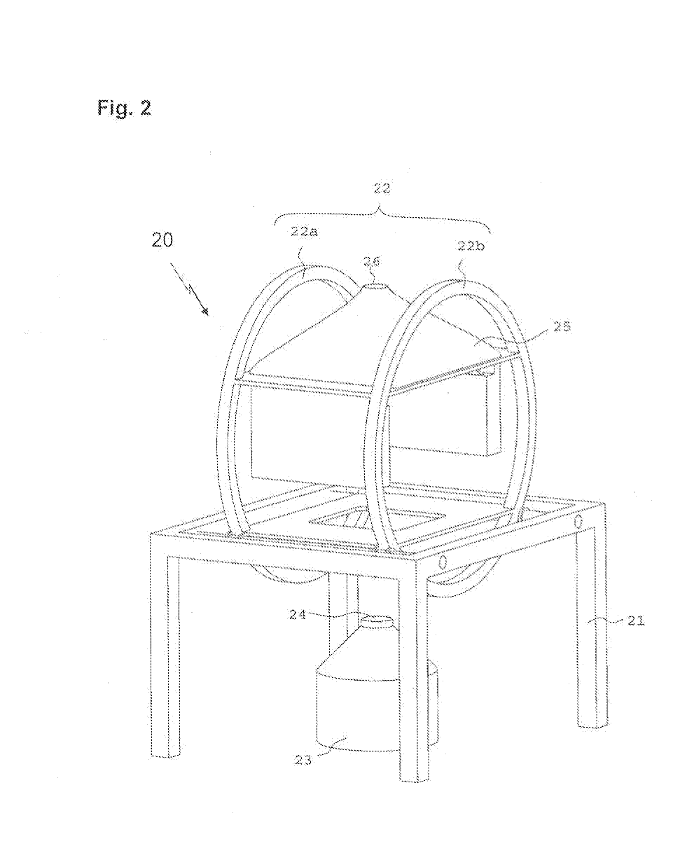

FIG. 2 shows a schematic perspective view of an unpacking station of the device shown in FIG. 1.

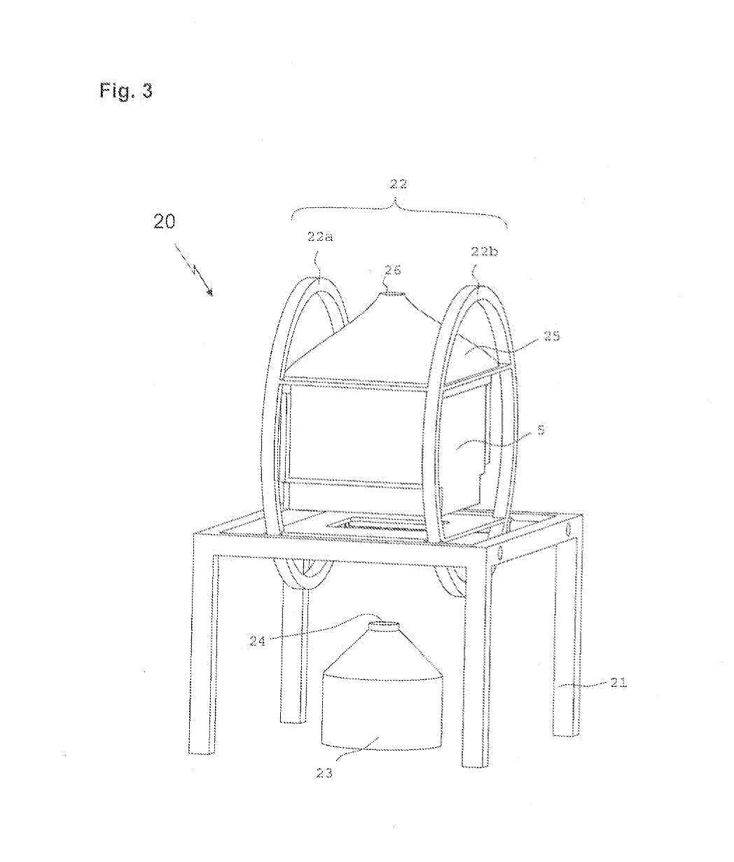

FIG. 3 shows a schematic perspective view of the unpacking station of FIG. 2, having the interchangeable container inserted.

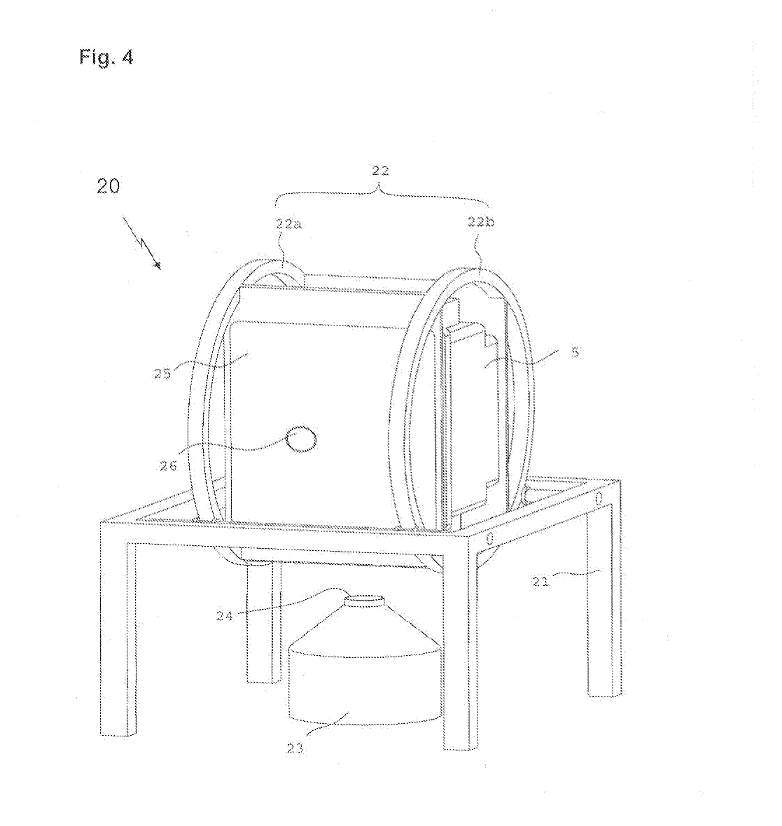

FIG. 4 shows a schematic perspective view of the unpacking station of FIG. 3, in a state in which the latter has been rotated by 90°.

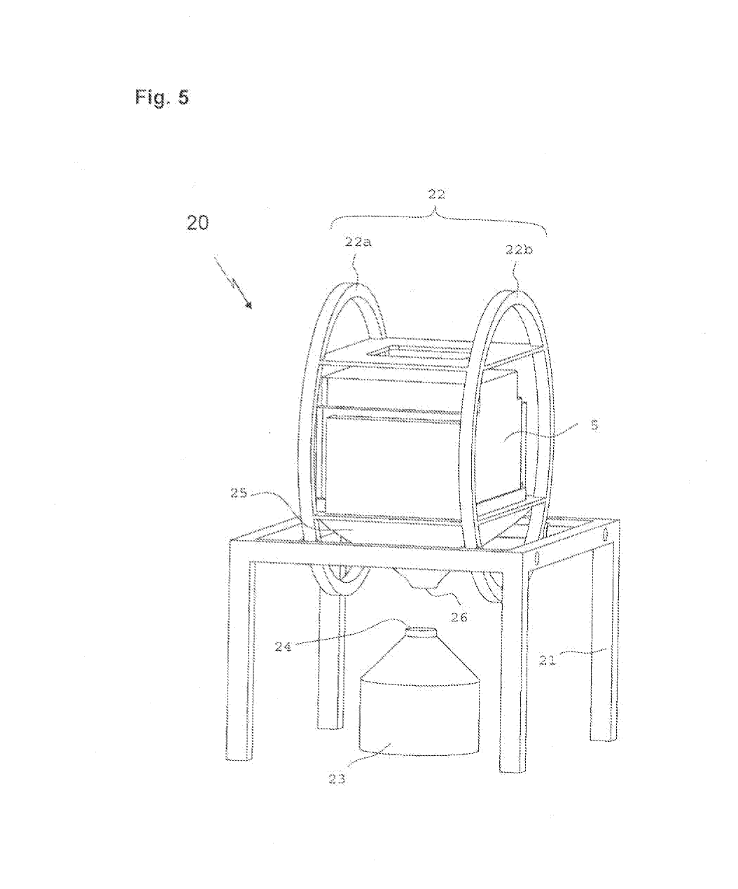

FIG. 5 shows a schematic perspective view of the unpacking station of FIG. 3, in a state in which the latter has been rotated by 180°.

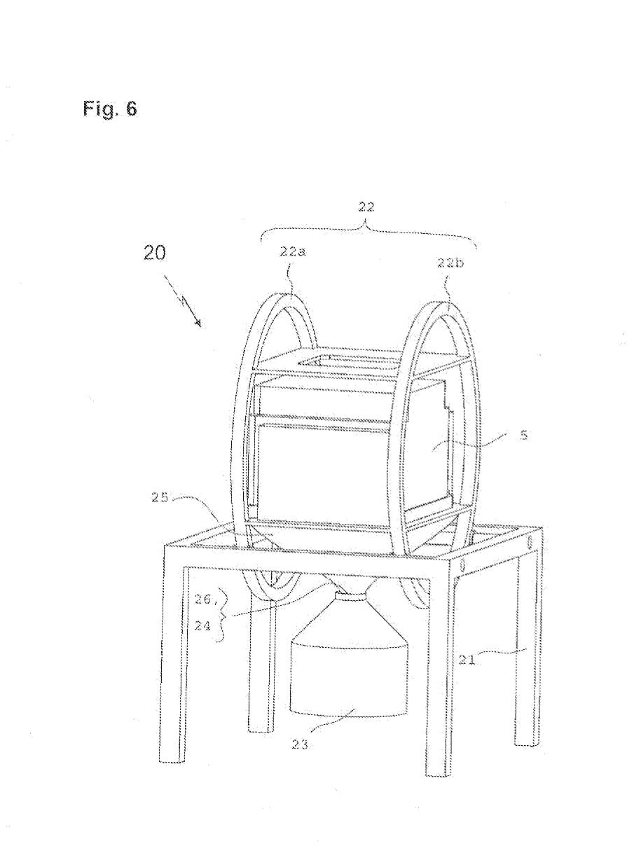

FIG. 6 shows a schematic perspective view of the unpacking station of FIG. 3, in a state in which the latter has been rotated by 180°, wherein a container lid has been docked onto a collection container.

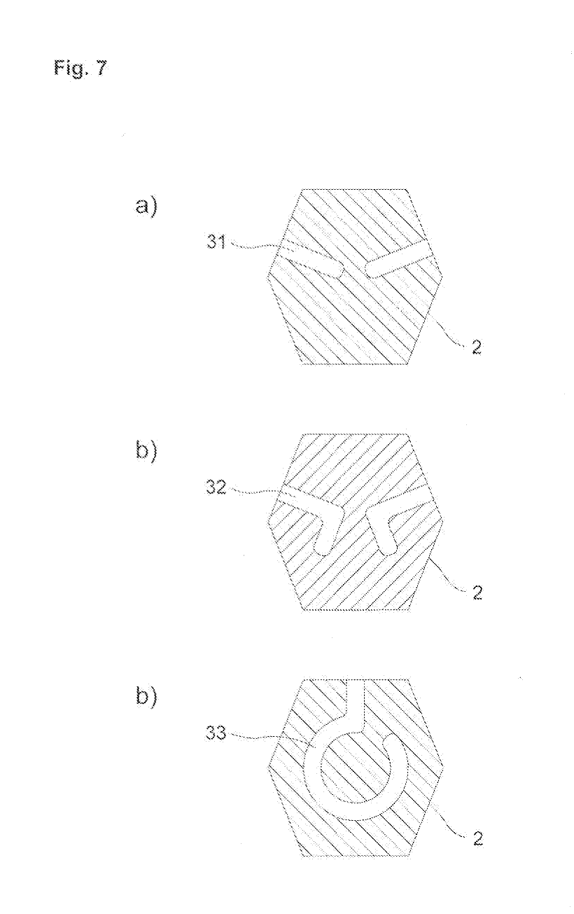

FIG. 7 schematically shows geometries of produced objects having internal ducts.

An exemplary embodiment of a device which is suitable for carrying out the present invention will be described hereunder with reference to FIG. 1. The device illustrated in FIG. 1 is a laser sintering or laser melting device 1. In order for the object 2 to be constructed, said device includes a processing chamber 3 having a chamber wall 4.

A container 5 which is open at the top and which is configured as an interchangeable container is disposed in the processing chamber 3, meaning that said container 5 may be removed from the processing chamber 3 and re-inserted thereinto. A support 6, which is movable in a vertical direction V and on which a base plate 6a which closes off the interchangeable container toward the bottom and thus forms the base of the latter is attached, is disposed in the container 5. The base plate 6a may be a plate which is formed separately from the support 6 and which is fastened to the support 6, or may be formed so as to be integral with the support 6. Depending on the process used, a construction platform 7 on which the object 2 is constructed may also be attached to the base plate 6a. However, the object 2 may also be constructed on the base plate 6a which then itself serves as the construction platform.

In FIG. 1 the object 2 which is to be formed in the container 5 on the construction platform 7 is illustrated below an operation level 8 in an intermediate state, having a plurality of solidified layers and surrounded by remaining non-solidified building material 9. Furthermore, a storage container 10 for a pulverulent building material 11 which is solidifiable by electromagnetic radiation, and a coating unit 12, which is movable in a horizontal direction H, for applying the building material 11 onto the operation plane 8 are disposed in the processing chamber 3.

The laser sintering device 1 furthermore includes an irradiation device 13 having a laser 14 which generates a laser beam 15 which is deflected by way of a deflection device 16 and by way of a focusing device 17 via a launching window 18 in the wall of the processing chamber 3 is focused onto the operation plane 8.

The laser sintering device 1 furthermore includes a controller 19 by way of which the individual component parts of the device are controlled in a coordinated manner for carrying out the construction process. The controller may include a CPU, the operation of which is controlled by a computer program (software).

The laser sintering device 1 finally includes an unpacking station 20 for unpacking the object 2 from the remaining non-solidified powder 9 surrounding said object 2.

FIG. 2 shows a schematic perspective view of the interior of the unpacking station 20. Any housing that may potentially be present has been omitted in order for the illustration to be simplified.

The unpacking station 20 includes a stationary frame 21 having a rotary frame 22. The rotary frame 22 is attached to the frame 21 such that the former is rotatable about a horizontally running axis. In the example illustrated in the figure, the rotary axis runs through the centers of the two circular rings which form the rotary frame 22. The rotary frame 22 is configured such that it is capable of receiving an interchangeable container 5. A lid 25 which is capable of closing the interchangeable container 5 inserted into the rotary frame 22 is attached to the rotary frame 22.

A collection container 23 which on the upper side thereof has a collection opening 24 is disposed below the rotary frame 22 in the frame 21. Preferably, the collection opening 24 is closable, for example by a slide (not shown). Furthermore, the collection container 23 may have a discharge or evacuation opening (likewise not shown) for removing the collected powder.

During operation the interchangeable container 5 is initially disposed in the processing chamber 3, in order for the object 2 to be produced. The support 6 is lowered by the desired layer thickness and, using the coating unit 13, a layer of the pulverulent building material 12 is then applied. Subsequently, the cross section of the object to be produced is scanned by the laser beam 15 such that the pulverulent building material 12 is solidified at these locations. These steps are repeated until the object has been finished.

In order for the object 2 to be unpacked from the remaining non-solidified powder 9 surrounding said object 2, the interchangeable container 5 is moved into the unpacking station 20 and inserted into the rotary frame 22. FIG. 3 shows the unpacking station 20 in that state in which the interchangeable container 5 has been inserted. Here, the lid 25 closes the interchangeable container 5 toward the top. The lid 25 on the upper side thereof has an outlet opening 26 for the remaining non-solidified powder 9. This outlet opening 26 is initially closed using a slide (not illustrated in the figures).

As is illustrated in FIG. 4, the rotary frame 22 having the interchangeable container 5 received therein is subsequently rotated about a horizontal rotation axis. In the terminal position (rotary angle 180°) shown in FIG. 5, the outlet opening 26 of the lid 25 points down and lies opposite the collection opening 24 of the collection container 23. In this position the slide of the lid 25 keeps the outlet opening 26 free, and the remaining non-solidified powder 9 may trickle into the collection container 23 placed there below. The object 2 is formed on the construction platform 7 and is either connected directly to the latter, for example by having been sintered directly thereonto, or is formed on a base plate which is fastened to the construction platform 7. Said object 2 thus does not fall down, even in the case of rotation by 180°.

Upon having been emptied of remaining non-solidified powder 9, the interchangeable container 5 is removed from the unpacking station 20, the lid 25 is removed, and the object 2 is released from the construction platform 7. Unpacking of the object 2 is thus completed.

In order for the release of powder 9 from the object 2 to be assisted, vibrations may be transmitted to the object 2. These vibrations are applied to the interchangeable container 5 from the outside, preferable onto the base plate 6a or the construction platform 7, respectively, which are disposed in the interchangeable container 5 and hold the object. Here, it is preferably ensured by suitable damping measures that the vibrations do not spread to other parts of the device, such as to the irradiation device or to the processing chamber, for example, in which a further object is potentially already being simultaneously produced, so as not to compromise the production accuracy of said object.

Instead of vibrations, that is to say continuous oscillation, or additionally thereto, knocks, that is to say individual successive impacts, may also be transmitted to the object 2.

Depending on the geometric data available for the production of the object and on various process parameters, such as, for example, the type and the grain size of the powder used, the layer thickness, a duration of exposure to the laser, or a temperature of the powder during processing, the parameters for vibrating or for knocking may be selected in a suitable manner, and the unpacking device 20 may accordingly be controlled. In the case of vibrations, said parameters are, for example, frequency, direction, amplitude, duration, or pulse shape of the oscillation, in the case of knocking, said parameters are, for example, intensity or direction of the individual impacts, or the temporal spacing thereof. This selection and control may also be carried out in a computer-assisted manner by way of software.

As is shown in FIG. 6, the lid 25 of the interchangeable container may be docked onto the lid of the collection container 23. In this case, a closed and gas-tight interior space which is formed by the interchangeable container 5 and the collection container 23 and may be filled with inert gas is created, such that emptying of the interchangeable container 5 may be carried out in an inert-gas atmosphere. Since the object 2 and the powder 9 are typically still hot during unpacking, undesirable reactions may be avoided on account of said inert-gas atmosphere. Alternatively however, the entire interior of the unpacking station 20 may be filled with inert gas. When the outlet opening 26 of the lid 25 and/or the collection opening 24 of the collection container 23 are configured so as to be closable, the inert-gas atmosphere in the interchangeable container 5 and/or the collection container 23 may also be maintained when the two latter are mutually separated.

Instead of being a fixed component part of the unpacking station 20, the lid 25 may also be separately provided. If an inert-gas atmosphere is not required, there is also no need for a lid to be placed onto the interchangeable container 5. Then, upon rotation of the interchangeable container 5, the powder trickles out of the open upper side of the latter. The collection opening 24 and the collection container 23 then have to be of sufficient size in order to be able to collect the powder trickling out.

In order for the powder to be removed without residue from the interchangeable container 5, the latter must be rotated by at least 90°, preferably by at least 120°, furthermore preferably by at least 150°, even more preferably by at least 180° from the upright position. The upright position is that position of the interchangeable container in which the outlet opening 26 points to the top and in which the object 2 has been produced. The rotation axis about which this rotation is performed here preferably runs in a horizontal manner. Arrangements in which there are no restrictions in terms of the angle and in which the interchangeable container may be rotated by more than 360°, for example, may also be used.

By way of the described method it is possible for objects which have been produced by solidifying pulverulent raw material in layers to be reliable relieved of the remaining non-solidified powder surrounding said objects. A dedicated drive for moving the support on which the object has been constructed is not required here. Moreover, the powder may also trickle out of cavities which using the described prior art cannot be relieved of powder. On account thereof, that the rotation axis in the case of the described rotary frame runs through the interchangeable container, the unpacking station may be constructed in a significantly more compact manner than in the case of a rotation axis below the container.

In order for removal of the powder from cavities, in particular from narrow ducts, to be improved, it may be advantageous for the interchangeable container to not be rotated by 180° but rather such that these ducts are as vertical as possible, so that the powder may readily trickle out of the ducts, potentially assisted by vibrating. Here, rotation by more than 180°, for example up to 270°, may also be advantageous. The preferred rotary angle of the rotary frame here is derived from the angle of the ducts in the object. Said rotary angle may be determined from the design data of the produced object, for example. This determination may also be performed in a computer-assisted manner by way of software which then controls rotation in a corresponding manner.

FIG. 7 schematically shows geometries of produced objects having internal ducts. A finished object 2 which includes two ducts 31 running in a straight line is illustrated in FIG. 7a). The interchangeable container 5 may initially be rotated by 180° in order for the majority of the non-solidified powder to be removed. In order for the ducts 31 to be relieved from non-solidified powder, the interchangeable container 5 is subsequently and preferably rotated such that the ducts are in each case vertical. For example, if the ducts have an angle of 60° in relation to the vertical, the interchangeable container 5 is brought to an angular position of 120° and 240° (=180°±60°). The initial position of 180° may be omitted if the angular positions are sufficient for the powder to be adequately removed from the interchangeable container 5.

A finished object Z which has two ducts 32 running at an angle is illustrated in FIG. 7b). In each case one angular position is not sufficient for emptying these ducts; rather the inner and the outer leg of the duct have to alternatingly be brought into a vertical position.

A finished object 2 which includes a duct 33 running in a curved manner is illustrated in FIG. 7c). In order for this duct to be emptied, a temporal succession of angular positions has to be set in order for the powder to be able to be removed even from the most distant end of the duct. This temporal succession may be determined from the geometric data available for producing the object, for example. This determination may also be performed in a computer-assisted manner by way of software which then controls the rotary frame 22 such that rotation of the interchangeable container 5 is carried out using the determined temporal succession of angular positions.

In order for the ducts to be able to be brought into vertical position independently of the position of the former in the object, it may be advantageous for more than one rotation axis to be provided. Arrangements in which the interchangeable container may be rotated in arbitrary directions may also be used.

While the unpacking station in the embodiment described is disposed as a dedicated station outside the processing chamber, the present invention is not limited thereto. The unpacking station may also be disposed within the processing chamber. The rotary frame may also be disposed such that the interchangeable container is already received in said rotary frame during production of the object and does not need to be transferred thereinto after the production of the object. All features which are described above in the context for the separately disposed unpacking station may then also be disposed in the processing chamber per se.

While an interchangeable container is used in the embodiment described, the present invention is not limited thereto. Said invention may also be applied in all cases in which no interchangeable container is available. In these cases, the powder may be initially removed from the finished object by suction or blowing. Then, only the construction platform on which the object has been constructed is transferred to the rotary frame and rotated, for example in order for powder to be removed from the openings which are included in the object. Alternatively, the construction platform may also be already inserted into the rotary frame during production of the object. As in the case of the interchangeable frame, the upright position from which the construction platform is rotated is that position of the construction platform in which the object has been produced.

While a rotary frame for rotating the interchangeable container or the construction platform, respectively, has been described in the embodiment described, the present invention is not limited thereto. For example, a turntable to which the interchangeable frame or the construction platform, respectively, is fastened, or any other arbitrary rotary device, may also be used.

While the present invention has been described by means of a laser sintering device or a laser melting device, respectively, said invention is not limited to laser sintering or laser melting. Said invention may be applied to arbitrary methods for producing a three-dimensional object by applying in layers and selectively solidifying a pulverulent building material by way of the influence of energy. For example, the laser may be a gas-state laser or a solid-state laser, a laser diode, or a laser-diode array. In general, any irradiation device by way of which energy may be selectively applied onto a pulverulent layer may be used. Another light source, an electron beam, or any other energy source or radiation source, respectively, which is suitable for solidifying the pulverulent building material, may be used instead of a laser, for example. The invention may also be applied to selective mask sintering in which a mask and an expanded light source are used instead of a displaceable laser beam, or to absorption sintering or inhibition sintering, respectively. The invention relates in particular to the production of an entire object by means of applying in layers and selectively solidifying a pulverulent building material alone in general, even in the case where solidifying is not performed by way of introducing energy, for example as in the case of 3D-printing or the ink-jet method.

Various types of powder may be used as a building material, in particular metal powders or plastics powders, or filled or mixed powders. The method according to the invention may be employed in a particularly advantageous manner for metal powders.

1. A device for unpacking a three-dimensional object, which has been produced in an interchangeable container and/or on a construction platform by applying in layers and selectively solidifying a pulverulent building material, from the remaining non-solidified powder surrounding said object, comprising:
a rotary device which is rotatably disposed and which is capable of receiving the interchangeable container and/or the construction platform and of rotating the latter by an angle of at least 90° from the upright position.

2. The device as claimed in claim 1, wherein the rotation axis about which the rotary device is rotatable in order for the interchangeable container and/or the construction platform to be rotated from the upright position runs in a horizontal manner.

3. The device as claimed in claim 1, wherein said device furthermore includes an installation for transmitting a vibration and/or knock to the object.

4. The device as claimed in claim 1, wherein said device furthermore includes:
a lid for closing the interchangeable container, and/or
a collection container for the remaining non-solidified powder.

5. The device as claimed in claim 4, wherein the collection container is configured such that the latter is capable of docking onto the lid which is capable of closing the interchangeable container such that a gas-tight interior space is created.

6. The device as claimed in claim 1, wherein the rotation axis about which the rotary device is rotatable in order for the interchangeable container to be rotated from the upright position thereof runs through that region of the rotary device that is specified for receiving the interchangeable container.

7. The device as claimed in claim 1, wherein the rotary device is configured such that the interchangeable container and/or the construction platform are/is rotatable about more than one rotation axis.

8. A device for producing a three-dimensional object by applying in layers and selectively solidifying a pulverulent building material, having
a processing chamber for producing the object in layers in an interchangeable container and/or on a construction platform, and
a device for unpacking the object from the remaining non-solidified powder surrounding said object, as claimed in claim 1.

9. The device as claimed in claim 8, wherein the unpacking device is disposed outside the processing chamber.

10. The device as claimed in claim 8, wherein the unpacking device is disposed within the processing chamber such that the interchangeable container and/or the construction platform are/is already received in the rotary device during production of the object.

11. A method for relieving a three-dimensional object, which has been produced in an interchangeable container and/or on a construction platform by applying in layers and selectively solidifying a pulverulent building material, from remaining non-solidified powder, the method including the steps:
attaching the construction platform to a rotary device,
rotating the interchangeable container and/or the construction platform by an angle of at least 90° from the upright position.

12. The method as claimed in claim 11, said method furthermore including a step of transmitting vibrations and/or knocks to the object.

13. The method as claimed in claim 12, wherein
parameters for vibrating and/or knocking are determined from geometric data of the three-dimensional object and/or from process parameters, and
the unpacking device is controlled so as to carry out vibrating and/or knocking using the determined parameters.

14. The method as claimed in claim 13, wherein
determining the parameters is performed in a computer-assisted manner by way of software, and
the unpacking device is controlled by the software so as to carry out vibrating and/or knocking using the determined parameters.

15. The method as claimed in claim 14, wherein
the parameters for vibrating are selected from frequency and/or direction and/or amplitude and/or duration and/or impulse profile and/or
the parameters for knocking are selected from intensity and/or direction and/or temporal spacing of the individual impacts.

16. The method as claimed in claim 15, wherein said method
prior to attaching the interchangeable container to the rotary device includes closing the interchangeable container by way of a lid which has a closable outlet opening,
wherein the outlet opening is opened once the rotary device has been rotated.

17. The method as claimed in claim 16, wherein said method
prior to opening the outlet opening includes a step of docking the outlet opening of the lid onto a collection opening of a collection container, so as to form a gas-tight interior space.

18. The method as claimed in claim 17, wherein the interior space formed by the interchangeable container, closed by the lid, and by the collection container is filled with inert gas.

19. The method as claimed in claim 11, wherein the interchangeable container is rotated about a rotary axis which runs through the interchangeable container.

20. The method as claimed in claim 11, wherein the interchangeable container and/or the construction platform are/is rotated about more than one rotation axis.

21. The method as claimed in claim 11, wherein
an angle and/or a temporal sequence of angular settings is determined from geometric data of the three-dimensional object, and
the rotary device is controlled so as to carry out rotation of the interchangeable container and/or of the construction platform using the determined angle and/or the determined temporal sequence of angular settings.

22. The method as claimed in claim 21, wherein
determining the angle and/or the temporal sequence of angular settings is performed in a computer-assisted manner by way of software, and
the rotary device is controlled by the software.

23. A method for producing a three-dimensional object by applying in layers and selectively solidifying a pulverulent building material, the method including the steps:
constructing the object in an interchangeable container and/or on a construction platform, and
removing remaining non-solidified powder from the object by a method as claimed in claim 11.

24. The method as claimed in claim 23, wherein the interchangeable container and/or the construction platform are/is already received in the rotary device during production of the object.
